(19) United States
(12) Patent Application Publication
(10) Pub. No.: US 2015/0071614 A1
(43) Pub. Date: Mar. 12, 2015

(54) Creating, Editing, and Publishing a Video Using a Mobile Device

(71) Applicant: MixBit, Inc., San Mateo, CA (US)

(72) Inventors: Chad M. Hurley, Atherton, CA (US); Richard J. Plom, Clayton, CA (US); Walter C. Hsueh, San Mateo, CA (US)

(21) Appl. No.: 14/539,129

(22) Filed: Nov. 12, 2014

Related U.S. Application Data
(62) Division of application No. 13/894,431, filed on May 15, 2013.

(51) Int. Cl. G11B 27/031; H04N 19/40; H04N 21/2743; H04N 5/262

(52) U.S. Cl. CPC G11B 27/031; H04N 5/2628; H04N 19/40; H04N 21/2743
USPC 386/278

(57) ABSTRACT

Video is processed. Multiple raw video clips and data that describes a video project that includes the multiple raw video clips are received from a mobile device. The multiple raw video clips were captured using an integrated camera of the mobile device. The multiple raw video clips are processed to generate multiple intermediate video clips. The multiple intermediate video clips all have a same first video resolution and a same first aspect ratio. The multiple intermediate video clips are concatenated, in an order specified by the video project data, to generate a concatenated video.

### CROSS-REFERENCE TO RELATED APPLICATION

This application is a divisional of co-pending U.S. application Ser. No. 13/894,431, filed May 15, 2013, which is incorporated by reference herein in its entirety.

### BACKGROUND

1. Technical Field

The present invention generally relates to the field of video production and, in particular, to creating, editing, and publishing a video using a mobile device.

2. Background Information

Many mobile devices, such as smart phones and tablet computers, include an integrated camera that can capture video content. It is relatively easy for someone to use such a mobile device to generate a video clip and share that video clip with other people (e.g., by uploading the clip to a video sharing website). However, it is very difficult (or even impossible) to use such a mobile device to generate an entire video project, which can include multiple clips and various editing effects, and share that project.

### SUMMARY

The above and other issues are addressed by a method, non-transitory computer-readable storage medium, and system for producing a video using a mobile device that includes an integrated camera. An embodiment of the method comprises capturing multiple video clips using the camera. The method further comprises generating data that describes a video project. The video project includes the multiple video clips. The method further comprises sending, to a server, the video project data and the multiple video clips. The method further comprises receiving, from the server, a pointer to the video project stored in a playable format.

An embodiment of the medium stores executable computer program instructions for producing a video using a mobile device that includes an integrated camera. The instructions capture multiple video clips using the camera. The instructions further generate data that describes a video project. The video project includes the multiple video clips. The instructions further send, to a server, the video project data and the multiple video clips. The instructions further receive, from the server, a pointer to the video project stored in a playable format.

An embodiment of the system for producing a video using a mobile device that includes an integrated camera comprises at least one non-transitory computer-readable storage medium storing executable computer program instructions. The instructions comprise instructions for capturing multiple video clips using the camera. The instructions further generate data that describes a video project. The video project includes the multiple video clips. The instructions further send, to a server, the video project data and the multiple video clips. The instructions further receive, from the server, a pointer to the video project stored in a playable format.

### BRIEF DESCRIPTION OF THE DRAWINGS

FIG. 1 is a high-level block diagram illustrating an environment for producing a video using a mobile device, according to one embodiment.

FIG. 2 is a high-level block diagram illustrating an example of a computer for use as one or more of the entities illustrated in FIG. 1, according to one embodiment.

FIG. 3 is a high-level block diagram illustrating the video production module from FIG. 1, according to one embodiment.

FIG. 4 is a high-level block diagram illustrating the server from FIG. 1, according to one embodiment.

FIG. 5 is a flowchart illustrating a method of producing a video using a mobile device, according to one embodiment.

FIG. 6 is a portion of a graphical user interface that represents a clip graph, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

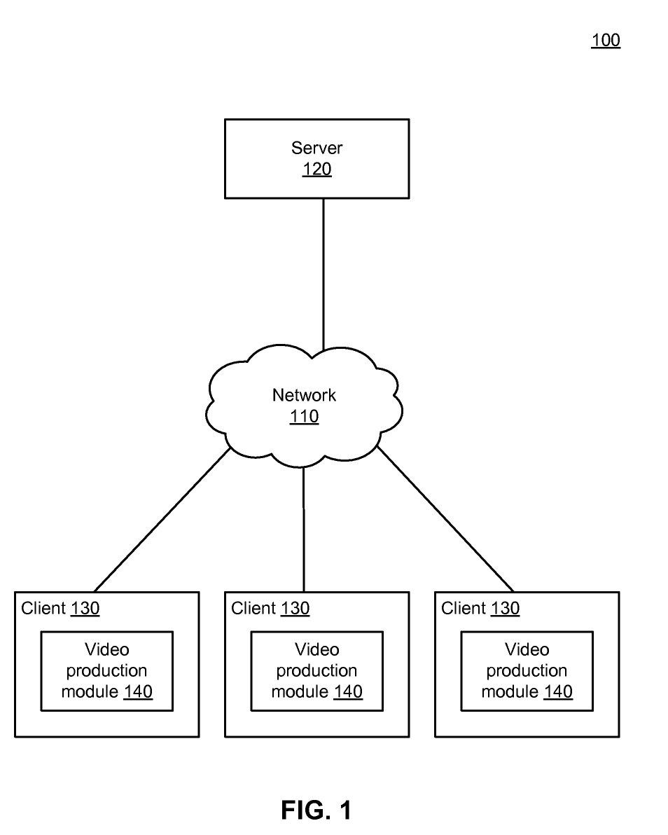

FIG. 1 is a high-level block diagram illustrating an environment 100 for producing a video using a mobile device, according to one embodiment. The environment 100 may be maintained by an enterprise that enables videos to be produced using mobile devices, such as a corporation, university, or government agency. As shown, the environment 100 includes a network 110, a server 120, and multiple clients 130. While one server 120 and three clients 130 are shown in the embodiment depicted in FIG. 1, other embodiments can have different numbers of servers 120 and/or clients 130.

The network 110 represents the communication pathway between the server 120 and the clients 130. In one embodiment, the network 110 uses standard communications technologies and/or protocols and can include the Internet. Thus, the network 110 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 110 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), etc. The data exchanged over the network 110 can be represented using technologies and/or formats including image data in binary form (e.g. Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 110 can use custom and/or dedicated data communications technologies instead of, or in addition to, the ones described above.

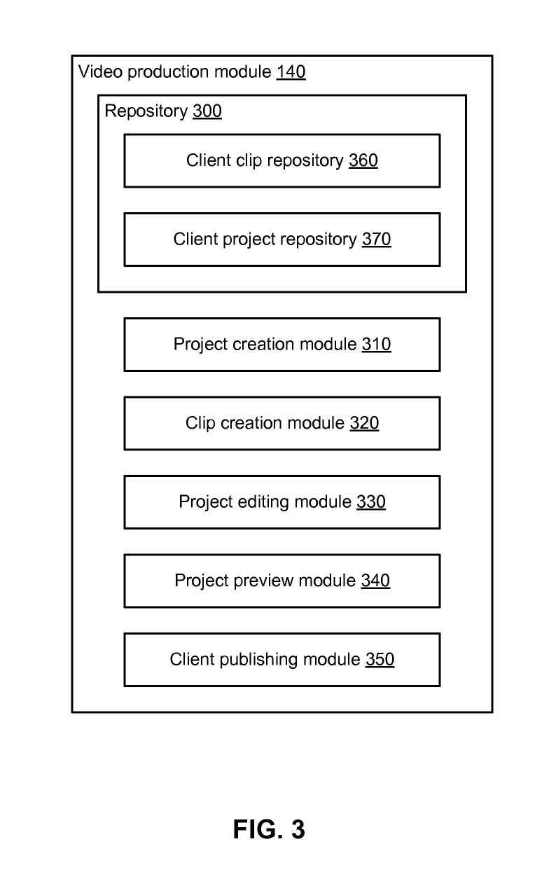

A client 130 is a mobile device such as a smart phone or tablet computer. The client 130 includes an integrated camera (not shown) that can capture video content. The client 130 also includes a video production module 140 that enables a user to produce a video. For example, the video production module 140 enables a user to create a video project, create a video clip, edit a video project, preview a video project, and publish a video project (e.g., by sending the video project to the server 120). The video production module 140 is further described below with reference to FIG. 3.

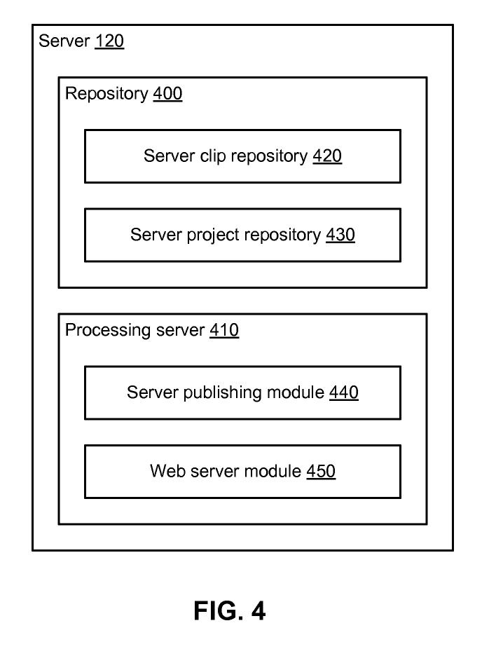

The server 120 is a computer (or set of computers) that stores video data. The video data includes data received from clients 130 (including data regarding video projects and data regarding video clips contained within those projects) and data generated by the server itself. The server 120 allows devices to access the stored video data via the network 110, thereby enabling sharing of the video data. For example, a video project stored on the server 120 can be shared with a client 130 so that the client 130 can display the video project. As another example, a video clip stored on the server 120 can be shared with a client 130 so that the client 130 can use the video clip when creating a video project. Other types of devices (e.g., laptop computers, desktop computers, televisions, set-top boxes, and other networked devices) (not shown) can also access the stored video data (e.g., to display video projects and/or to use video clips when creating video projects). The server 120 is further described below with reference to FIG. 4.

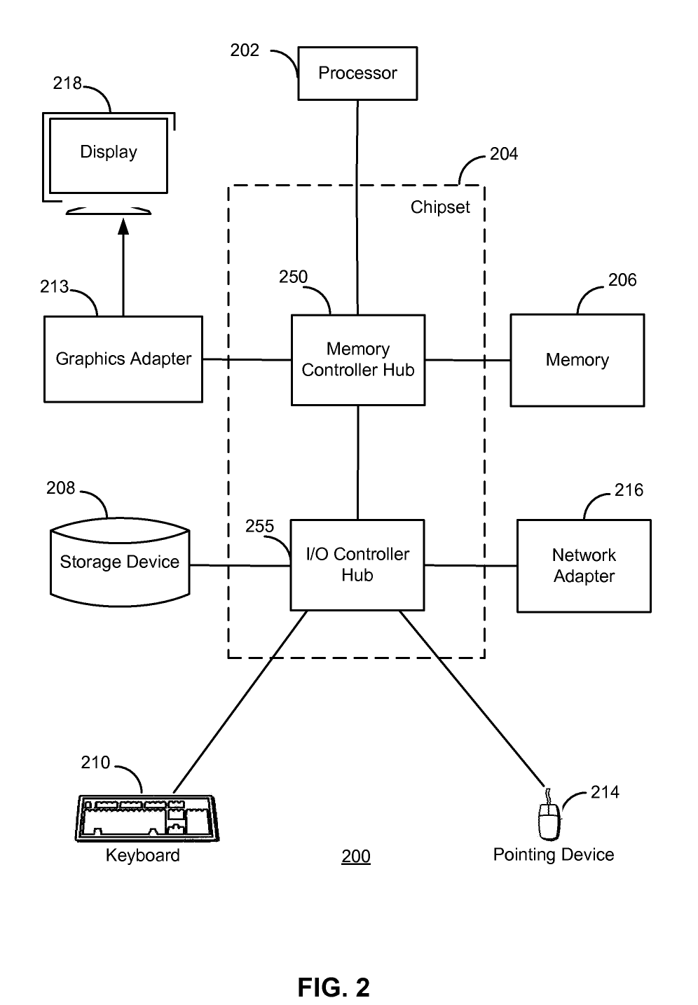

FIG. 2 is a high-level block diagram illustrating an example of a computer for use as one or more of the entities illustrated in FIG. 1, according to one embodiment. Illustrated are at least one processor 202 coupled to a chipset 204. The chipset 204 includes a memory controller hub 250 and an input/output (I/O) controller hub 255. A memory 206 and a graphics adapter 213 are coupled to the memory controller hub 250, and a display device 218 is coupled to the graphics adapter 213. A storage device 208, keyboard 210, pointing device 214, and network adapter 216 are coupled to the I/O controller hub 255. Other embodiments of the computer 200 have different architectures. For example, the memory 206 is directly coupled to the processor 202 in some embodiments.

The storage device 208 includes one or more non-transitory computer-readable storage media such as a hard drive, compact disk read-only memory (CD-ROM), DVD, or a solid-state memory device. The memory 206 holds instructions and data used by the processor 202. The pointing device 214 is used in combination with the keyboard 210 to input data into the computer system 200. The graphics adapter 213 displays images and other information on the display device 218. In some embodiments, the display device 218 includes a touch screen capability for receiving user input and selections. The network adapter 216 couples the computer system 200 to the network 110. Some embodiments of the computer 200 have different and/or other components than those shown in FIG. 2. For example, the server 120 can be formed of multiple blade servers and lack a display device, keyboard, and other components. Also, the client 130 can include an integrated camera that can capture video content.

The computer 200 is adapted to execute computer program modules for providing functionality described herein. As used herein, the term “module” refers to computer program instructions and/or other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

FIG. 3 is a high-level block diagram illustrating the video production module 140 from FIG. 1, according to one embodiment. The video production module 140 includes a repository 300, a project creation module 310, a clip creation module 320, a project editing module 330, a project preview module 340, and a client publishing module 350. The repository 300 stores a client clip repository 360 and a client project repository 370.

The client clip repository 360 stores client data entries for one or more video clips. A client data entry for one video clip includes an actual video clip and metadata regarding that clip. An actual video clip is, for example, a file that adheres to a video storage format and can be played. Client metadata regarding a clip includes, for example, a time duration (e.g., 5 seconds), a video resolution (e.g., 640 pixels by 360 pixels or 480 pixels by 480 pixels), an aspect ratio (e.g., square or 16:9), a file format (e.g., .mov (QuickTime) or .jpg (Joint Photographic Experts Group (JPEG))), a camera orientation (e.g., portrait or landscape), a video bitrate, an audio bitrate, a Global Positioning System (GPS) tag, a date/timestamp (indicating when the clip was captured), and/or a unique identifier.

The client project repository 370 stores client data entries for one or more video projects. A client data entry for one video project includes a list of clips, instructions regarding how those clips should be assembled, and metadata regarding the project. The list identifies clips by, for example, each clip's unique identifier. The assembly instructions refer to the listed clips in the order that the clips should be presented within the project. (Note that a single clip can be shown multiple times within one project if desired.) Metadata regarding a project includes, for example, title, hashtags (e.g., “#ocean”), location (e.g., a Foursquare venue identifier, GPS tag, and/or latitude/longitude/altitude), and/or number of unique clips in the project.

The project creation module 310 creates a video project. For example, the project creation module 310 creates a new client data entry in the client project repository 370 to store client data for the new video project and populates that entry with any known information. In one embodiment, the project creation module 310 also launches the clip creation module 320 so that the user can create a video clip.

The clip creation module 320 creates a video clip. For example, the clip creation module 320 creates a new client data entry in the client clip repository 360 to store client data for the new video clip and populates that entry with any known information. The clip creation module 320 uses the integrated camera of the client 130 to capture video content. The clip creation module 320 then stores data, including the captured video content, in the newly-created entry. The clip creation module 320 also adds the newly-created clip to the currently-selected project (e.g., by storing in the project's data entry the clip's unique identifier in the list of clips and indicating in the assembly instructions when the clip should be shown).

In one embodiment, the clip creation module 320 displays a graphical user interface (GUI) that enables a user to capture video by touching (e.g., pressing down on and holding) a touch screen of the client 130. Specifically, when the user first begins to touch the touch screen, the video capture starts. When the user stops touching the touch screen, the video capture stops, and a video clip is created. If this process is repeated (e.g., the user touches the touch screen again and then stops touching it), then a separate clip is created.

The project editing module 330 edits an existing video project. For example, the project editing module 330 modifies an existing entry in the client project repository 370 that represents a particular project. To move around an existing clip within the same project (thereby changing the order of clips within the project), the project editing module 330 modifies the existing project entry by indicating in the assembly instructions when the reordered clip should be shown. To add a new clip to the project, the project editing module 330 modifies the existing project entry by storing the clip's unique identifier in the list of clips and indicating in the assembly instructions when the clip should be shown. To duplicate an existing clip, the project editing module 330 modifies the existing project entry by indicating in the assembly instructions when the clip should be shown again. To trim an existing clip, there are two possibilities: If the clip is to be trimmed only when it is used in the current project (referred to as “virtual trimming”), then the project editing module 330 modifies the existing project entry by indicating the start time and the stop time of the trimmed clip (relative to the duration of the entire untrimmed clip) and the duration of the trimmed clip. If the clip is to be trimmed for all purposes (e.g., when used in any project), then the project editing module 330 modifies the existing project entry by indicating the duration of the trimmed clip. Also, the relevant entry in the client clip repository 360 is modified by replacing the original (untrimmed) actual video clip with the trimmed video clip and updating the clip's metadata (e.g., the duration of the clip). To delete an existing clip, the project editing module 330 modifies the existing project entry by removing the clip occurrence in the assembly instructions. If the clip is no longer present anywhere in the project, then the project editing module 330 also removes the clip's unique identifier from the list of clips.

In one embodiment, the project editing module 330 displays a GUI that enables a user to edit an existing video project. For example, regarding moving around an existing clip within the same project, the GUI includes a thumbnail image for each clip within the project, displayed in order of occurrence. In response to a user indicating (e.g., pressing down on and holding) a thumbnail image, that thumbnail image becomes selected and can be dragged and dropped to a different position, such that the corresponding clip will be shown at a different point in time within the video project. In one embodiment, when a thumbnail image becomes selected, the user is notified of the selection by the thumbnail increasing in size and wiggling.

In one embodiment, when one clip is currently being displayed (e.g., when a playing video project has been paused), the GUI includes a button with a plus (+) icon and a button with a minus (−) icon. In response to a user indicating (e.g., tapping) the plus icon button, a pop-up menu is displayed that includes items for “Duplicate Clip”, “Import Clip”, and “Duplicate Project” (or similar). In response to the user indicating (e.g., tapping) the Duplicate Clip item, the displayed clip is duplicated within the current project. In response to the user indicating (e.g., tapping) the Import Clip item, a list of video clips accessible to the client 130 is shown. These clips can be stored, for example, on the client 130 or on the server 120. Also, these clips might have been created by the client 130 or by a different device. In response to the user indicating (e.g., tapping) a particular clip, that clip is added to the current project. In response to the user indicating (e.g., tapping) the Duplicate Project item, the current project is duplicated. For example, a new client data entry is created within the client project repository 370 that is similar to the existing client data entry for the current project.

In response to a user indicating (e.g., tapping) the minus icon button, a pop-up menu is displayed that includes items for “Delete Clip”, “Trim Clip”, and “Delete Project” (or similar). In response to the user indicating (e.g., tapping) the Delete Clip item, the occurrence of the displayed clip is deleted from the current project. In response to the user indicating (e.g., tapping) the Trim Clip item, a GUI is displayed that enables the user to trim the displayed clip. In one embodiment, this GUI enables the user to specify the start time and the stop time of the trimmed clip (relative to the duration of the entire untrimmed clip) and to specify whether the clip is to be trimmed only when it is used in the current project (referred to as “virtual trimming”) or that the clip should be trimmed for all purposes (e.g., when used in any project). In response to the user indicating (e.g., tapping) the Delete Project item, the current project is deleted. For example, the existing entry in the client project repository 370 that represents the current project is deleted. If the clips used by that project are not used by any other projects, then the clips are deleted from the client clip repository 360 (e.g., the existing entries in the client clip repository 360 that represent those clips are deleted). If the clips used by that project are also used by other projects, then the clips are not deleted from the client clip repository 360.

The project preview module 340 plays a current video project so that the user can see what the project looks like. Specifically, the project preview module 340 accesses the entry in the client project repository 370 that stores the client data for the current video project. The project preview module 340 uses the project entry to determine which clips are in the video project and the order in which those clips should be played. Then, the project preview module 340 plays each clip in the specified order seamlessly, thereby indicating what the finished project should look like. Note that the clips are not concatenated into a single file. Instead, the clips remain in separate files but are “swapped” in and out (i.e., played sequentially with very little or no breaks in-between).

Note that the video project might contain video clips with different camera orientations. For example, a first clip might have a portrait orientation, and a second clip might have a landscape orientation. Showing these clips sequentially, without modification, would result in a video preview that changes orientation and looks awkward. In this situation, the video preview shows one or more of the clips in a cropped manner so that the cropped clip matches the other clips' orientations. For example, a clip that has a camera orientation of portrait would have its top and/or bottom portions cropped out to achieve an aspect ratio of 4:3, which is used by landscape orientation. In one embodiment, the top portion and the bottom portion are cropped out in equal amounts, such that the cropped clip shows the middle portion of the original portrait clip. In another embodiment, the top portion is cropped out less than the bottom portion (referred to as an “upper crop”), such that the cropped clip shows the upper-middle portion of the original portrait clip. In one embodiment, the ability to play multiple clips seamlessly in a specified order is referred to as “real-time splicing.”

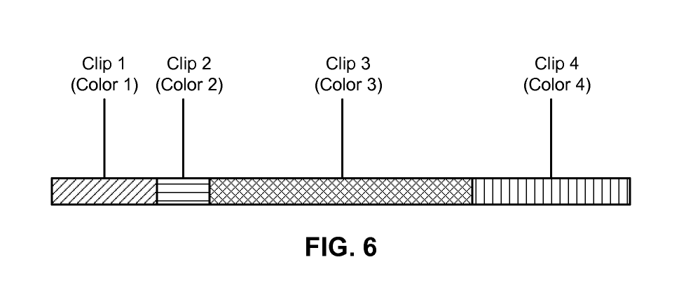

In one embodiment, the project preview module 340 displays a GUI that includes both the playing video project and additional information. The additional information includes, for example, a “clip graph” alongside (e.g., underneath) the playing video. FIG. 6 is a portion of a GUI that represents a clip graph, according to one embodiment. A clip graph is a compact timeline-type representation of a video project and its constituent video clips. The width of the clip graph, in its entirety, represents the total duration of the video project. Within the clip graph, different clips are represented by rectangular blocks with different appearances, where the width of a block represents the duration of the corresponding clip (relative to the duration of the video project as a whole). In FIG. 6, the blocks are shown with different fill patterns. Note that these different fill patterns can be replaced by different colors, as indicated by the labels in FIG. 6 (e.g., “Clip 1 (Color 1)”). Also, the height of the clip graph can be reduced to as small as one pixel. In one embodiment, as a video project is playing, a progress indicator (not shown) moves along the clip graph to indicate which portion of the project is currently being played. In one embodiment, the progress indicator is an object that is separate from the clip graph (e.g., a tick mark or a slider thumb). In another embodiment, the progress indicator is integrated into the clip graph by using color differentiation. For example, portions of the project that have already been played are shown with brighter/more vibrant colors, and portions of the project that have not yet been played are shown with duller/more faded colors.

In one embodiment, the project preview module 340 enables a user to dub sound into the current video project. For example, the project preview module 340 displays a GUI that includes a button with a microphone icon. While the project is playing, the user can indicate (e.g., tap) the microphone button. Responsive to receiving this user input, the project preview module 340 uses a microphone of the client 130 to capture ambient sounds (e.g., the user narrating the video). Responsive to receiving user input that indicates (e.g., taps) the microphone button again, the sound capture ends. The captured sounds are then used as the soundtrack of the project, rather than the soundtrack that was captured when the clips were originally captured. In one embodiment, the captured sounds are stored in a file that adheres to an audio format. The relevant entry in the client project repository 370 is then modified to reference the audio file and to indicate when the audio file should be played (relative to the duration of the project as a whole).

The client publishing module 350 publishes a video project so that the project can be shared. For example, the client publishing module 350 accesses the entry in the client project repository 370 that stores the client data for the current video project. The client publishing module 350 uses the project entry to determine which clips are in the video project. Then, the client publishing module 350 accesses the entries in the client clip repository 360 that store the client data for the clips that are part of the project. Finally, the client publishing module 350 sends the project entry and the relevant clip entries to the server 120. As further described below, the server 120 then uses the project entry and the clip entries to generate a file that contains the video project in a playable format and stores the file.

In one embodiment, after the server 120 receives the project entry and the clip entries, the server 120 sends to the client 130 a pointer to the video project as stored by the server 120. In this embodiment, after the client publishing module 350 sends the project entry and the clip entries to the server 120, the client publishing module 350 receives from the server 120 a pointer to the video project. The pointer enables the published project to be shared. For example, a device sends the pointer to the server 120 and, in response, is able to access and display (e.g., play back) the published project. In one embodiment, the pointer is a uniform resource locator (URL), and a device navigates a web browser to that URL to access and display (e.g., play back) the published project. In one embodiment, the client publishing module 350 enables the user to easily distribute the received pointer (e.g., by emailing the pointer or by posting the pointer to a social network such as Facebook or Twitter).

FIG. 4 is a high-level block diagram illustrating the server 120 from FIG. 1, according to one embodiment. The server 120 includes a repository 400 and a processing server 410. The repository 400 stores a server clip repository 420 and a server project repository 430. The processing server 410 includes a server publishing module 440 and a web server module 450.

The server clip repository 420 stores server data entries for one or more video clips. A server data entry for one video clip includes multiple actual video clips and metadata regarding those clips. An actual video clip is, for example, a file that adheres to a video storage format and can be played. In one embodiment, the multiple actual video clips include an original video clip received from a client 130 (e.g., using client publishing module 350) (referred to as a “raw clip”) and one or more versions of the raw clip that have been resized and further compressed into new versions of the clip (referred to as “processed clips”) that are suitable for streaming at various video resolutions and in various file formats. This way, the clip can be viewed by devices that have different capabilities. For example, consider two resolutions (640 pixels by 360 pixels and 480 pixels by 480 pixels) and two formats (.mp4 (H.264/MPEG-4) and .ogv (Ogg Vorbis)). To accommodate all of the possible combinations, four processed clips would be stored: 640×360/mp4, 480×480/mp4, 640×360/ogv, and 480×480/ogv.

Server metadata regarding a clip includes, for example, a time duration (e.g., 5 seconds), a video resolution (e.g., 640 pixels by 360 pixels or 480 pixels by 480 pixels), an aspect ratio (e.g., square or 16:9), a file format (e.g., .mov (QuickTime) or .jpg (JPEG)), a camera orientation (e.g., portrait or landscape), a video bitrate, an audio bitrate, a GPS tag, a date/timestamp (indicating when the clip was captured), and/or a unique identifier. Note that this metadata is stored for each clip, including the raw clip and the processed clips.

The server project repository 430 stores server data entries for one or more video projects. A server data entry for one video project includes a list of clips, instructions regarding how those clips should be assembled, one or more actual videos, metadata regarding those videos, and metadata regarding the project. The list of clips and the instructions regarding how those clips should be assembled are similar to those received from a client 130 (e.g., using client publishing module 350).

An actual video is, for example, a file that adheres to a video storage format and can be played. Also, an actual video is a concatenation of multiple clips. In one embodiment, the one or more actual videos represent the same video project but are suitable for streaming at various video resolutions and in various file formats. This way, the video project can be viewed by devices that have different capabilities. For example, consider two video resolutions (640 pixels by 360 pixels and 480 pixels by 480 pixels) and two file formats (.mp4 (H.264/MPEG-4) and .ogv (Ogg Vorbis)). To accommodate all of the possible combinations, four versions of the video project would be stored: 640×360/mp4, 480×480/mp4, 640×360/ogv, and 480×480/ogv.

The metadata regarding a video includes, for example, a time duration (e.g., 5 seconds), a video resolution (e.g., 640 pixels by 360 pixels or 480 pixels by 480 pixels), an aspect ratio (e.g., square or 16:9), a file format (e.g., .mov (QuickTime) or .jpg (JPEG)), a camera orientation (e.g., portrait or landscape), a video bitrate, an audio bitrate, a GPS tag, a date/timestamp (indicating when the clip was captured), and/or a unique identifier. Note that this metadata is stored for each video project version.

Server metadata regarding a project includes, for example, title, hashtags (e.g., “#ocean”), location (e.g., a Foursquare venue identifier, GPS tag, and/or latitude/longitude/altitude), number of unique clips in the project, IP address, various flags (ready, finished, private, spam, adult), video file name, video width, video height, video length, thumbnail file name, thumbnail width, thumbnail height, version, various resolutions (preferred, supported, current/default), various timestamps (created, updated), and/or supported codecs.

The server publishing module 440 receives video data from a client 130, processes that data, populates the server clip repository 420 and the server project repository 430 accordingly, and sends the client 130 a pointer to the published video project. For example, the server publishing module 440 receives, from a client 130, one project entry (originally stored in the client project repository 370) and one or more clip entries (originally stored in the client clip repository 360).

Regarding the one project entry, the server publishing module 440 generates one or more versions of the video project (e.g., suitable for streaming at various video resolutions and in various file formats). The server publishing module 440 then stores these versions, along with the relevant metadata etc., in the server project repository 430. Recall that a single video project can include clips that were created by different devices. For example, a project can include a first clip that was created by a first device and a second clip that was created by a second device. These clips might differ in terms of video resolution, aspect ratio, file format, camera orientation, video bitrate, audio bitrate, etc. In this situation, the first clip might need to be processed (e.g., to modify its characteristics) before it can be combined with the second clip to form a version of the video project.

In one embodiment, a video project version is created as follows: First, the raw video clips that are used in the project are processed to generate intermediate video clips, which all have the same video resolution and aspect ratio (e.g., 640×360 and 16:9, respectively). This step, referred to as “smart splicing”, enables clips with disparate resolution and/or aspect ratio characteristics to be concatenated together. The processing can include rotating and/or cropping the raw clips. For example, a clip that has a camera orientation of portrait would have its top and/or bottom portions cropped out to achieve an aspect ratio of 4:3, 16:9, or 1:1. In one embodiment, the top portion and the bottom portion are cropped out in equal amounts, such that the resulting intermediate clip shows the middle portion of the original portrait clip. In another embodiment, the top portion is cropped out less than the bottom portion (referred to as an “upper crop”), such that the resulting intermediate clip shows the upper-middle portion of the original portrait clip. Next, the intermediate clips are concatenated together. Finally, the resulting concatenated video is transcoded into the desired resolution and format.

Regarding the one or more clip entries, the server publishing module 440 generates one or more versions of each raw clip (e.g., suitable for streaming at various video resolutions and in various file formats) by transcoding the raw clip into one or more processed clips. The server publishing module 440 then stores these processed clips, along with the raw clip and the relevant metadata etc., in the server clip repository 420. The server 120 also sends the client 130 a pointer to the published video project (e.g., a URL).

The web server module 450 receives requests from devices to access video projects and responds to those requests accordingly. For example, the web server module 450 receives a Hypertext Transfer Protocol (HTTP) request from a web browser installed on a device. The HTTP request includes a URL that indicates a particular video project. In response to receiving the HTTP request, the web server module 450 sends the device an appropriate version of the requested video project. Specifically, if the URL includes a query string that indicates a video resolution, then the sent version is at the indicated resolution (otherwise, a default resolution is used). If the URL includes a query string that indicates a file format, then the sent version is at the indicated format (otherwise, a default format is used). For example, an HTTP request might include a URL that includes a query string that indicates a resolution of 640×360 (16:9 aspect ratio) and a format of mp4.

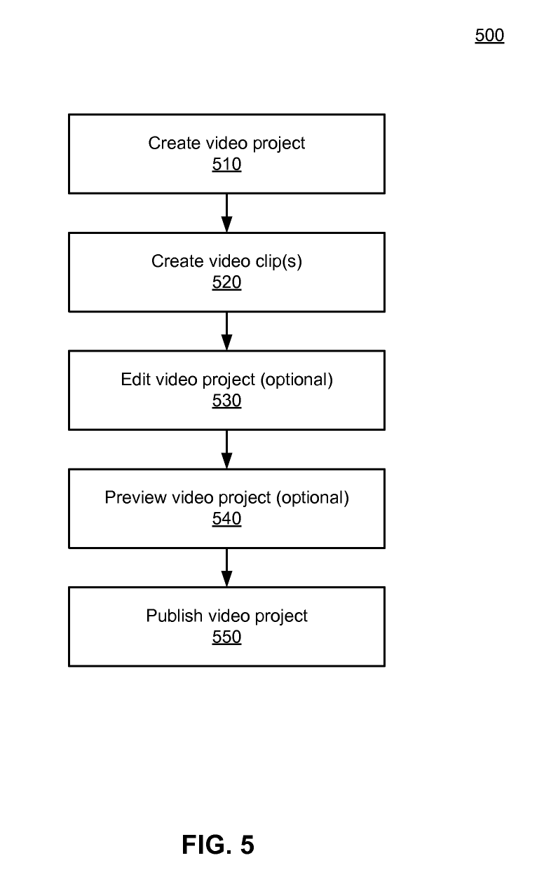

FIG. 5 is a flowchart illustrating a method 500 of producing a video using a mobile device, according to one embodiment. Other embodiments can perform the steps in different orders and can include different and/or additional steps. In addition, some or all of the steps can be performed by entities other than those shown in FIG. 1.

In one embodiment, the video production module 140 displays a GUI that includes a menu with one or more items that enable a user to produce a video using the client 130. These menu items include, for example, “New Project” (or similar). In response to receiving user input that indicates (e.g., taps) the New Project menu item, the video production module 140 launches the project creation module 310. In another embodiment, the video production module 140 displays a GUI that includes a square button with a framed plus (+) icon. In response to receiving user input that indicates (e.g., taps) the framed plus icon button, the video production module 140 launches the project creation module 310. At this point, the method 500 begins.

In step 510, a video project is created. For example, as described above, the project creation module 310 creates a new entry in the client project repository 370 to store client data for the new video project and populates that entry with any known information. The project creation module 310 also launches the clip creation module 320 so that the user can create a video clip.

In step 520, one or more clips are created. For example, as described above, the clip creation module 320 creates a new entry in the client clip repository 360 to store client data for the new video clip and populates that entry with any known information. The clip creation module 320 also uses the integrated camera of the client 130 to capture video content. The clip creation module 320 then stores data, including the captured video content, in the newly-created entry. The clip creation module 320 also adds the newly-created clip to the current project.

In step 530, which is optional, the video project is edited. For example, as described above, the project editing module 330 modifies the entry in the client project repository 370 that represents the current video project. Editing the video project can include moving around an existing clip within the same project, adding a new clip, duplicating an existing clip, trimming an existing clip, and deleting an existing clip.

In step 540, which is optional, the video project is previewed. For example, as described above, the project preview module 340 plays the video project so that the user can see what the project looks like. In one embodiment, the project preview module 340 is launched in response to receiving user input that indicates (e.g., taps) a “play” icon button (or similar).

In step 550, the video project is published. For example, as described above, the client publishing module 350 sends the relevant project entry and the relevant clip entries to the server 120. The client publishing module 350 also receives from the server 120 a pointer to the video project and distributes the received pointer. In one embodiment, the client publishing module 350 is launched in response to receiving user input that indicates (e.g., taps) an “Upload” button (or similar).

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A method for processing video, comprising:
receiving, from a mobile device that includes an integrated camera, multiple raw video clips that were captured using the camera and data that describes a video project that includes the multiple raw video clips;
processing the multiple raw video clips to generate multiple intermediate video clips, wherein the multiple intermediate video clips all have a same first video resolution and a same first aspect ratio; and
concatenating the multiple intermediate video clips, in an order specified by the video project data, to generate a concatenated video.

2. The method of claim 1, wherein processing the multiple raw video clips to generate multiple intermediate video clips comprises rotating one of the multiple raw video clips.

3. The method of claim 1, wherein processing the multiple raw video clips to generate multiple intermediate video clips comprises cropping one of the multiple raw video clips.

4. The method of claim 1, further comprising sending, to the mobile device, a pointer to the concatenated video.

5. The method of claim 1, further comprising transcoding the concatenated video into a second video resolution and a second aspect ratio.

6. A non-transitory computer-readable storage medium storing executable computer program instructions for processing video, the instructions performing steps comprising:
receiving, from a mobile device that includes an integrated camera, multiple raw video clips that were captured using the camera and data that describes a video project that includes the multiple raw video clips;
processing the multiple raw video clips to generate multiple intermediate video clips, wherein the multiple intermediate video clips all have a same first video resolution and a same first aspect ratio; and
concatenating the multiple intermediate video clips, in an order specified by the video project data, to generate a concatenated video.

7. The non-transitory computer-readable storage medium of claim 6, wherein processing the multiple raw video clips to generate multiple intermediate video clips comprises rotating one of the multiple raw video clips.

8. The non-transitory computer-readable storage medium of claim 6, wherein processing the multiple raw video clips to generate multiple intermediate video clips comprises cropping one of the multiple raw video clips.

9. The non-transitory computer-readable storage medium of claim 6, wherein the steps further comprise sending, to the mobile device, a pointer to the concatenated video.

10. The non-transitory computer-readable storage medium of claim 6, wherein the steps further comprise transcoding the concatenated video into a second video resolution and a second aspect ratio.

11. A system for processing video, the system comprising:
at least one non-transitory computer-readable storage medium storing executable computer program instructions comprising instructions for:
receiving, from a mobile device that includes an integrated camera, multiple raw video clips that were captured using the camera and data that describes a video project that includes the multiple raw video clips;
processing the multiple raw video clips to generate multiple intermediate video clips, wherein the multiple intermediate video clips all have a same first video resolution and a same first aspect ratio; and
concatenating the multiple intermediate video clips, in an order specified by the video project data, to generate a concatenated video; and
a processor for executing the computer program instructions.

12. The system of claim 11, wherein processing the multiple raw video clips to generate multiple intermediate video clips comprises rotating one of the multiple raw video clips.

13. The system of claim 11, wherein processing the multiple raw video clips to generate multiple intermediate video clips comprises cropping one of the multiple raw video clips.

14. The system of claim 11, wherein the executable computer program instructions further comprise instructions for sending, to the mobile device, a pointer to the concatenated video.

15. The system of claim 11, wherein the executable computer program instructions further comprise instructions for transcoding the concatenated video into a second video resolution and a second aspect ratio.
